(19) United States
(12) Patent Application Publication
(10) Pub. No.: US 2007/0143151 A1
(43) Pub. Date: Jun. 21, 2007

(54) Preventive health care device, system and method

(75) Inventors: Christopher T. Fey, McKinney, TX (US); Brian J. Baum, West Friendship, MD (US); Mark A. Calem, Oakton, VA (US); John W. Franks, Jacksonville, FL (US); Thomas Richardson, Denver, CO (US)

Correspondence Address: WILLIAMS MULLEN, 8270 GREENSBORO DRIVE, SUITE 700, MCLEAN, VA, 22102, US

(73) Assignee: U.S. Preventive Medicine, Inc.

(21) Appl. No.: 11/639,988

(22) Filed: Dec. 15, 2006

Related U.S. Application Data
(60) Provisional application No. 60/750,988, filed on Dec. 16, 2005.

(51) Int. Cl. G06F 19/00

(52) U.S. Cl. 705/3

(57) ABSTRACT

The present invention provides a system, method and device for assisting users in assessing individual health, deriving intervention programs and making health related decisions. A health assessment-intervention component collects and screens diagnostic and demographic data from clients and assists in forming health-care related decisions, action plans and treatment plans. The system can collect and maintain health-related data from third parties such as physicians, researchers, universities and the like, and can provide user accessible personal health records and health decision assistance. The invention can be implemented in numerous ways, including as a system, a device, a method, or a computer readable medium implemented as a smart drive device and/or keychain-type memory device, for example.

### REFERENCE TO RELATED APPLICATIONS

This application claims the benefit under 35 U.S.C. §119(e) of U.S. provisional patent application No. 60/750,988, filed Dec. 16, 2005 and entitled “System and Method for Managing and Influencing Decisions Related to Individual Health,” the disclosure of which is hereby incorporated by reference in its entirety.

### FIELD OF THE INVENTION

The present invention relates to personal wellness, and more particularly to a system, method and device for assisting users in assessing individual health, deriving intervention programs and making health related decisions.

### BACKGROUND OF THE INVENTION

Personal electronic medical records are a relatively recent phenomenon. Estimates are that more than 90 percent of the dissemination of health care related records and information currently occurs by telephone, facsimile and paper. Such paper-based systems are extremely costly, and also result in preventable medical errors such as faulty diagnoses and improper medicating of patients, for example.

Further, today's health industry is set up to fight diseases that have progressed so far that symptoms are noticed. This system makes it hard to arrange blood tests, imaging, in-depth physical exams and preventive action plans for people who show no signs of being sick. According to the Centers for Disease Control, the United States cannot effectively address escalating health care costs without addressing the problem of chronic diseases and how to prevent them. While many chronic disease processes can be slowed and their resulting human impact reduced, one needs to know how far these problems have progressed internally, and what to do to keep them from getting so bad that symptoms are noticed—when it may be too late to do anything effective. For example, preventive medicine professionals can often see diabetes prior to onset. Assessing body shape and blood chemistry test results can identify those with metabolic syndrome, a condition known to greatly raise the risk of developing Type-2 diabetes mellitus. Through often simple steps involving nutrition, exercise and medication, people can reduce their risks, as well as enjoy a much more active, vital and productive life.

### SUMMARY OF THE INVENTION

The present invention provides, in part, a health assessment-intervention system for collecting and screening diagnostic and demographic data from clients and assisting in forming health-care related decisions, action plans and treatment plans for clients. The invention can receive, process, manage and analyze health data from clients, as well as outside health risk assessments and screening tests. The present invention can further generate custom reports, collect and maintain health-related data from third parties such as physicians, researchers, universities and the like, and can provide user accessible personal health records and health decision assistance. The invention can be implemented in numerous ways, including as a system, a device, a method, or a computer readable medium implemented as a smart drive device, “thumb” drive, and/or keychain-type memory device, for example.

In another aspect, the present invention provides a system and method which assists existing medical providers in becoming leaders in predictive medicine, effectively detecting and reversing disease at the earliest stages with the ultimate result being maximized, high quality life for clients. Physicians can register with the system of the present invention in order to gain access to, and provide services for, member clients.

In another aspect, the present invention provides a system and method which assists conventional health care diagnostic and/or medical facilities in converting or adapting to assessment-intervention, or preventive, medical centers having prescribed routines for patient intake, handling, and information management, for example.

In another aspect, the present invention provides a system and method which provides users, clients and/or patients with an individual health intervention strategy based upon a standardized health assessment methodology.

In another aspect, the present invention provides a networked preventive medicine system for centralizing a knowledge base and best practices information for dispersed and/or distributed preventive medical centers.

In another aspect, the present invention provides a system and method for converting standalone health facilities to assessment-intervention facilities.

In another aspect, the present invention provides a system and method for determining the optimal testing approach in connection with an assessment-intervention health care system, with the testing approach being based in part upon age and gender of the participant.

In another aspect, the present invention provides a system and method for health care facilities and professionals to derive new revenue streams.

### BRIEF DESCRIPTION OF THE DRAWINGS

FIG. 1 is an illustration of a geographically dispersed network in accordance with the present invention.

FIG. 2 is a flow diagram illustrating client flow procedures in accordance with one aspect of the present invention.

FIG. 3 is a schematic diagram illustrating one embodiment of the present invention and various types of actors who may use or contribute to the system of the present invention.

FIG. 4 shows a sample health risk assessment document outline that can be used to collect client health information in accordance with one aspect of the present invention.

FIG. 5 is a flowchart illustrating certain process steps involved with one aspect of the present invention.

FIGS. 6 through 8 are sample screen shots that a client patient may encounter in using the present invention.

### DETAILED DESCRIPTION OF THE PREFERRED EMBODIMENTS

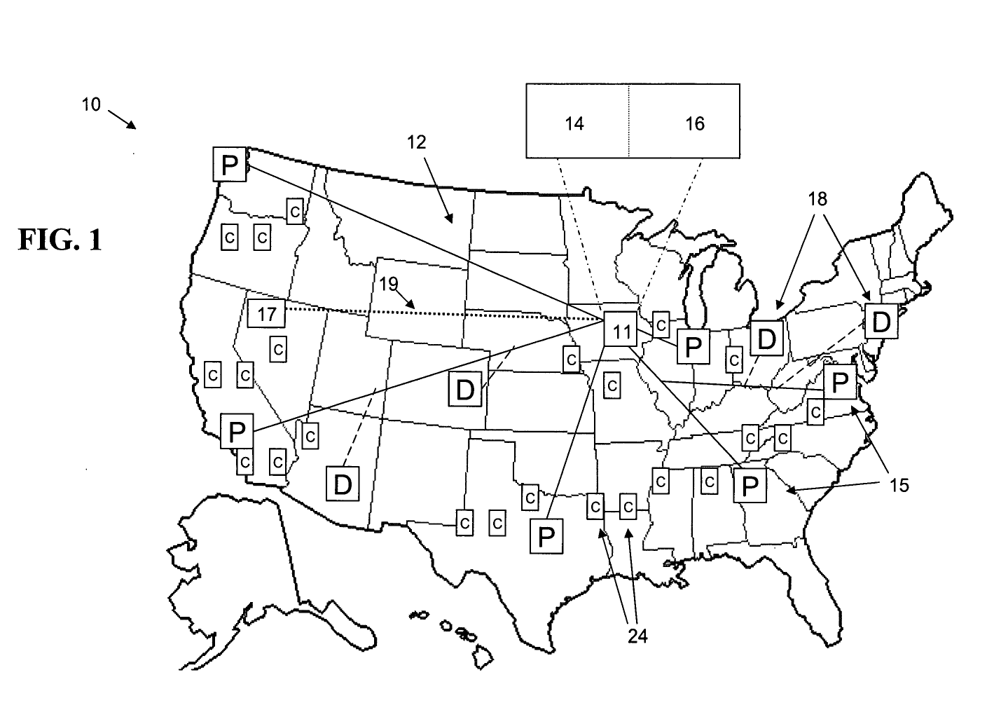

As shown in FIG. 1, the present invention provides a system 10 having a network 12 for facilitating health assessment and intervention, including medical and health information collection, distribution, management, and decision-assistance. The network 12 is illustrated in FIG. 1 as a wide area network (WAN) spanning the United States, but can also be implemented as, for example, a local area network (LAN), metropolitan area network (MAN), private network, telecommunications network, or publicly accessible network such as the Internet. In FIG. 1, there are provided a plurality of physical preventive medical centers 15 (or “assessment-intervention” facilities), wherein each center is equipped with at least diagnostic imaging equipment or laboratory testing equipment to facilitate testing in accordance with the present invention. The network 12 allows each of the medical centers to communicate with one another. The network provides access to a centralized management system 11, which can be embodied as a health facility operations management system 14 and/or a centralized preventive health management system 16. One or more health information content providers 18 are also provided in communication with the computer network. The content providers can be outsourced third party knowledge experts in particular health fields, and/or can be individual health care professionals who are members of the system described by the present invention, for example.

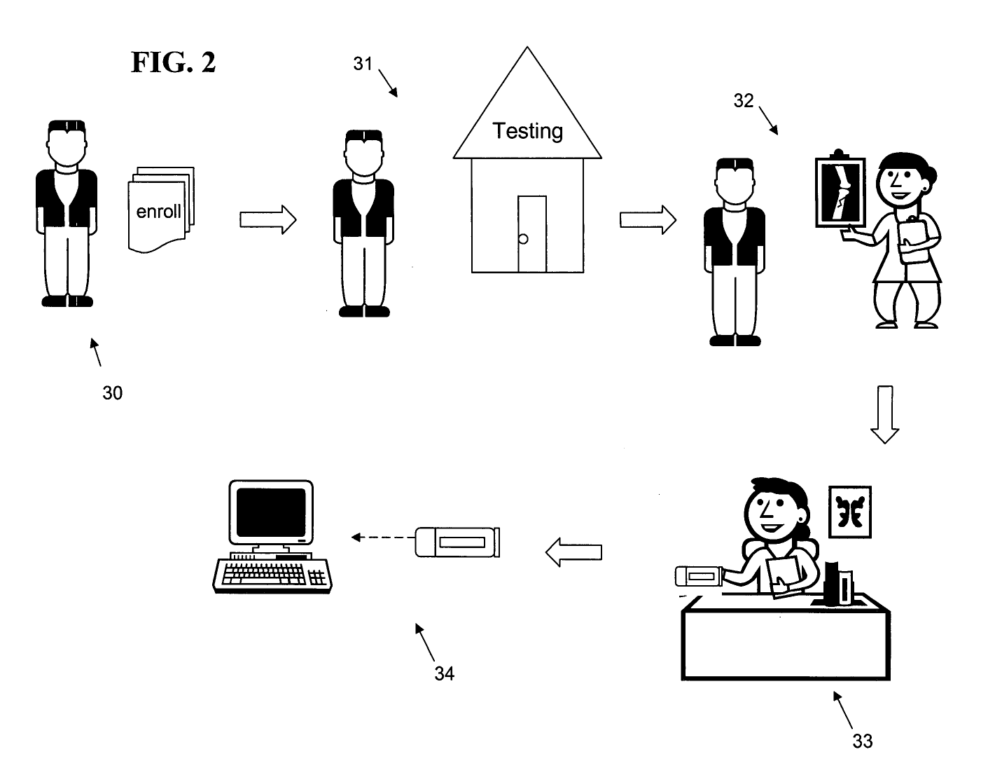

Clients 24 can enroll and receive benefits accorded by the system of the present invention as shown in FIG. 2. It will be understood that the term client can encompass a patient, a system user, a system participant, customer, or other individual interacting with the present invention. As illustrated at step 30 in FIG. 2, the client can enroll with the system electronically, by phone, facsimile or other well understood means, and the enrolling step can occur prior to or at the time of personally attending a physical medical center 15, which is illustrated at step 31. During the client's visit, and depending upon the level of assessment selected and/or advised for the client, the client will undergo a variety of tests and health assessments as illustrated at step 32. These assessments are conducted similar to a physical examination in some ways, but can be augmented by various blood and body assessments as described in more detail below. Before and/or during testing, the client is also asked to provide objective data about himself or herself to be used with the results of the personal assessment, as well as in advising the client and designing an intervention program, for example.

At the end of the client's visit, he or she is provided with a personal device for managing his or her health care information as illustrated at step 33. Among other things, the device can store health and wellness information, at least a portion of which is customized to the client based upon the externally conducted health tests. It will be appreciated that this information need not and preferably is not based upon self-reported data. It will further be appreciated that this information can include text, images, sound and video-formatted information for viewing on a personal computing device, as illustrated at step 34. Computing device can be a personal computer, a laptop computer, personal digital assistant, cellular telephone, vehicle computer or other computer device appropriately equipped with a processor, memory, programming and a visual interface for running the necessary programs to enable viewing of the provided information on the visual interface. Because the present invention provides the knowledge, assessment and intervention plan information in several formats, the user is not only assisted in understanding often complicated medical issues, but the user is more apt to watch, listen and learn through the appealing content.

In one aspect of the present invention, standalone medical facilities, such as a hospital adjunct building used by medical professionals, a diagnostic laboratory or an imaging laboratory, for example, can be converted into assessment-intervention facilities that are part of the network of assessment-intervention facilities provided in accordance with the present invention. Using FIG. 1 as an example, facility 17 is a standalone health facility operating outside of the networked facility structure of the present invention. Upon the facility 17 requesting and/or agreeing to become part of the network, centralized health facility operations management system 14 provides infrastructure elements as illustrated by dotted line 19 to facility 17 to help convert it to an assessment-intervention facility member within the network of assessment-intervention facilities. The infrastructure can include physical and electronic components. For example, a standard operating procedure (SOP) manager component can be manually or electronically delivered to the facility. The SOP details various center functions such as finances, programs, client intake, client treatment, information systems, communication systems, client processing protocol, client assessment options, equipment requirements, equipment conversion techniques, and other requirements necessary for successful conversion. The SOP can also include forms used before, during and after the client's personal visit, wherein the forms are updatable electronically as future use dictates.

In one embodiment of the present invention, the SOP includes implementation and operations details, such as, for example, (1) preventive health packages based upon age range and gender (e.g., under 39, basic, female; under 39, basic, male; 40-49, basic, female; 40-49, basic, male; over 50, basic, female; over 50, basic, male; basic-cardio; under 39, comprehensive, female; under 39, comprehensive, male; 40-49, comprehensive, female; 40-49, comprehensive, male; over 50, comprehensive, female; over 50, comprehensive, male; comprehensive-cardio; elite-female; elite-male; and a-la-carte offerings); (2) legal contracts; (3) client flow instructions, such as for prospecting clients, marketing clients, prospecting among client spheres of influence, information/data flow, client appointment and payment arrangements, laboratory flow, diagnostic testing flow, and physician review and examination; (4) customer service; (5) laboratory requirements and operating procedures; (6) radiology requirements and operating procedures; (7) compliance; (8) quality management; (9) physician network management; (10) information technology (IT) requirements; (11) consumer marketing strategy; (12) sales management; (13) public relations management; (14) training management; (15) health history questionnaires; (16) informed consent documentation; (17) physician review and examination details; (18) summary presentations and reports; (19) client summary explanations; (20) client reference materials for results; and/or (21) facilities management.

Within the physician review and examination of element (3) above, provisions within the SOP can be made for physician referral, review of the client's health history questionnaire answers, review of the client's diagnostic tests, physician examination, determination of the presence of abnormalities, and handling of the presence or absence of abnormalities, for example. Within the radiology element (6) of the above SOP, provisions can be made for diagnostic imaging tests, such as CT scans, MRIs, PET scans, ultrasound, echocardiogram, electrocardiogram (EKG), and mammogram, for example. Provisions can also be made for radiation safety procedures. CT scan particulars can also be provided for: CT virtual colonoscopy, CT virtual colonoscopy test, CT test of the heart and coronary arteries guidelines, CT lung test guidelines, CT colonography test guidelines, CT colonography tests, CT heart scans, CT heart scans for calcium in the coronary arteries and CT policy guidelines, for example. Provisions can further be made for ultrasound screenings, including, for example, carotid ultrasound screens, thyroid ultrasound screens. Provisions can further be made for mammogram/breast cancer screenings. Provisions can further be made for DEXA (Dual x-ray Absorptometry) screenings, such as, for example, osteoporosis, risk factors, symptoms, treatments, detection and fall prevention.

Within the information technology element (10) above, the SOP can outline core business processes, sales and customer relationship management (CRM), scheduling, purchasing, pricing, client management, communications, hardware configuration, Internet connectivity, website content management, website marketing, desktop personal software and future system and hardware/software enhancements, for example.

Within the consumer marketing strategy of element (11) above, the SOP of the present invention can include, for example, consumer target audiences, marketing methods, direct marketing, consumer seminars, speakers bureaus, advertising, publicity, referrals, employers and customer service training and accountability processes.

Within the sales element (12) above, the SOP of the present invention can manage, for example, tools and techniques, sales qualification level descriptions, sales activities, sales management tools, CRM software, and mass e-mailing techniques and compliance. Within the training element (14) above, the SOP of the present invention can address service excellence, medical personnel training, sales personnel training, standards of procedure, and operations.

Within the physician review and examination element (17) above, the SOP of the present invention can address, for example: tests and ranges, body composition, blood pressures and pulse, cholesterol and triglyceride levels, ankle brachial index, carotid ultrasound, abdominal aortic aneurysm/ultrasound, echocardiogram/ultrasound, diabetes, osteoporosis, oxygen saturation, thyroid ultrasound screen, urine analysis, CT scans-cardiovascular, CT scans-lung cancer, CT scans-colon cancer, nutrition studies, liposcience lab cardiovascular studies, cancer studies, breast cancer, thyroid, arthritis studies, lupus studies, genetic disorders, chemistry panel, complete blood count, hormones, and/or hepatitis panel. It will be appreciated that the above items shall not be considered as inclusive or exclusive, and combinations of the above items with items and tests not listed are within the scope of the invention presently contemplated.

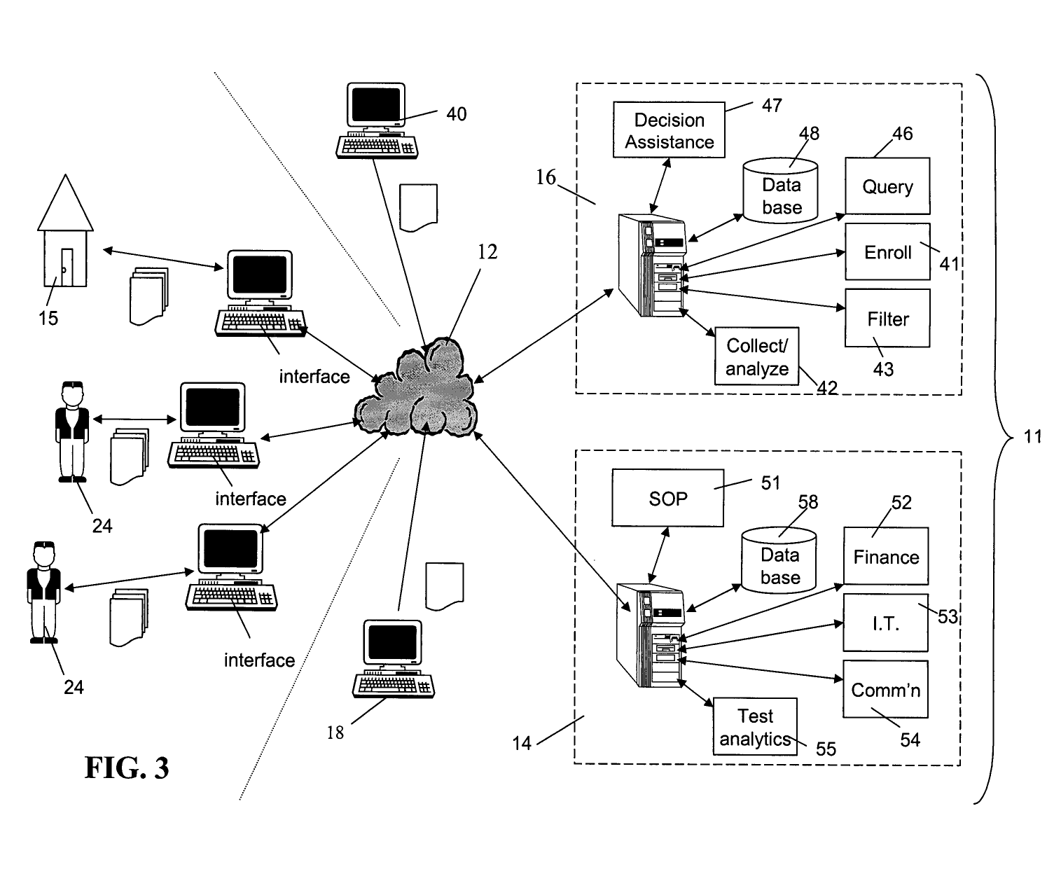

As shown in FIG. 3, the central management system 11 can include the centralized health facility operations management system 14 and the centralized preventive health management system 16. Systems 14 and 16 can further include one or more servers having appropriately dedicated processing capability and various components accessible over a network. The components can be separate and distinct computer program elements or integrated portions of computer program elements. For example, the preventive health management system 14 of the present invention includes an enrollment component 41, which can allow a client (e.g., patient) and/or a provider such as a physician to enroll with the system of the present invention. The enrollment component can be centrally managed, or can be delivered to the facility (e.g., through the SOP described above) for local use. By enrolling, a client can provide his or her own medical history and condition information into the system, and receive targeted information from the system and third party providers over the course of membership. A client services interface 42 is provided in communication with the computer network 12 for providing client informational services to one or more clients 24 attending one of the preventive medical centers. Such information can include, for example, best practices information and decision assistance with regard to current and future potential health conditions and situations. By enrolling, a client also receives the benefit of electronic management of his or her medical and health information, which, in one embodiment, can be represented in a USB memory device (e.g., a smart drive device) as described above for ease of portability and use in connection with member facilities. Clients who enroll can further be given an assessment according to one or more predetermined testing procedures, based upon the depth of analysis required by the client. For example, a basic package may provide the client with blood pressure, EKG and other tests and results, while a comprehensive package may provide colonoscopy, ultrasound and other more advanced tests. Based upon the assessment performed, clients can further receive intervention plans customized to their age, gender and health assessment.

Physicians who enroll with the system of the present invention gain access to clients and/or potential patients who may find the physician particularly suitable for dealing with the client's health situation. Physicians can further provide valuable diagnostic or preventive information and analysis for use by one or more clients in accordance with the present invention. A separate physician or health care professional user interface 40 is provided for such access and interaction.

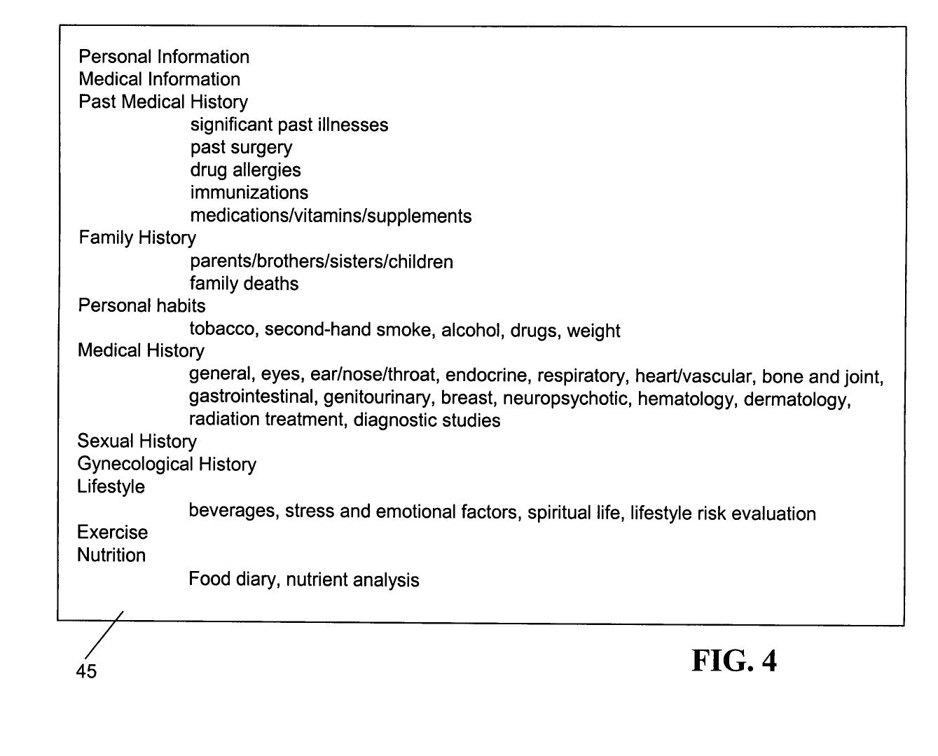

In addition to the enrollment component 41, the preventive health management system of the present invention can include a client medical history and medical condition collection and analysis component 42. This component manages the receipt, manipulation, analysis and storage of client input, wherein the input can relate to personal identification information, medical problems, medical history, surgeries, allergies, immunizations, vitamins and medicines, prescriptions, family health history, alcohol and drug use, vital sign information, diet, physical inspection information, CT exam results, heart/arteries exam results, lung exam results, colonography exam results, radiation exam results and ultrasound exam results, for example. Intuitively, the more information the client inputs into the system, the better the system of the present invention can work to help the client manage his or her health for lifelong wellness and decision assistance. FIG. 4 shows a sample Health Risk Assessment document outline 45 that can produce an assessment document for collection of client health information, for example.

The preventive health management system of the present invention further includes a filter engine 43 for collecting third party data pertaining to a client medical history, a client medical condition or general health information such as diet, exercise and the like, and making available all or a subset of the third party data to a client. Third parties 18 who may enter information for consideration and distribution by the present invention can include physicians (treating or referring), associations, research communities, universities, international experts, dieticians, nutritionists, trainers, and other field-specific experts whose information or practices can assist in a client's knowledge base or decision-making. It will be appreciated that third party providers can be screened by the system of the present invention to ensure that the individual submitting information is qualified and that the information submitted is sufficiently vetted for use in accordance with the present invention.

As further shown in FIG. 3, the system of the present invention can be provided with a query engine 46 for receiving one or more questions or requests for search pertaining to a medical situation, and for obtaining information in response to the question or request. The query engine 46 can work to obtain information from the client, or to obtain information on behalf of the client. In the former situation, the query engine 46 can be implemented so as to present structured questions to clients in order to assist the system in drawing elements of a productive intervention program. For example, the system may store structured questions in the system database (which may be provided, incidentally, by a physician or other third party provider), which direct one of multiple possible conclusions depending upon the answers received from the client. In a specific example, if the line of questions is provided in order to determine whether the client may be prone to skin cancer, the questions may ask for the client's heritage and/or family history of skin cancer.

Separately, the query engine 46 can be implemented so as to receive questions from clients in targeted or open-ended format. For example, if a client desires to know what factors may or may not predispose the client to skin cancer, he or she can ask the question using the query engine. Upon receipt of the question, the query engine 46 can access the system database 48 to determine what information is already stored in the system. The query engine can also send requests to known or registered resources (e.g., third party providers 18) in order to obtain even more recent information on the subject in real time. In one embodiment of the present invention, web resource addresses are stored and web services are available to direct the system of the present invention to the most relevant information available for answering the client's questions.

As further shown in FIG. 3, the system of the present invention also includes a decision-assistance engine 47 for providing assistance, recommendations, statistics, odds and possible outcomes associated with a client medical history or client medical condition. Such decision assistance can be provided as stored programs which are executed using received client information. The programs can be built using previously known data for a wide variety of individuals of different backgrounds and health histories. In one embodiment, the decision assistance engine receives information from a client's personal visit, adds any subjective data received about the client, and executes programming to provide a draft intervention recommendation pertaining to the client's health, based upon statistical analysis and past successful treatments and interventions stored in the database. This draft intervention recommendation can be transmitted to a physician (preferably the attending physician for the client) for review, editing and customizing on behalf of the client. Collected information pertaining to clients via the enrollment, analysis, filter, query and decision assistance components can be stored in database 48.

As further shown in FIG. 3, the centralized health facility operations management system 14 can include components such as the SOP component 51, finance component 52, information technology (IT) component 53, communications component 54 and test analytics component 55. The SOP component 51 can be communicated to a member facility 15 through the network 12, and can include the necessary infrastructure to assist new member facilities in becoming part of the network of assessment-intervention facilities. Finance 52, IT 53 and Communications 54 components can provide centrally hosted services for each of the member facilities, and it will be appreciated that other business functions capable of central hosting can be provided within the centralized health facility operations management system 14. Testing analytics component 55 can collect post-testing information from clients (non-private data), aggregate the data, and analyze the data to determine whether certain clients having particular readings and/or other characteristics might influence the testing prescribed for the individual assessment-intervention facilities. For example, if the system of the present invention manages health assessment and intervention information for 70 million people, and if 2000 are shown to develop arthritis due to an average of forty hours per week at a computer keyboard, then the testing analytics component 55 can operate so as to recommend an adaptation to either a health assessment questionnaire or a health assessment test performed for new clients. Such adaptations can be universally made once, so as to affect all later assessments at all member facilities. In the above example, the testing analytics component 55 might revise the health assessment questionnaire to include a question pertaining to the number of hours a new client sits and types at a keyboard per week. As a further example, the testing analytics component might revise the testing for arthritis to include a hand pain threshold test. Collected information pertaining to health facilities and the SOP, finance, IT, communications, test analytics and other components can be stored in database 58.

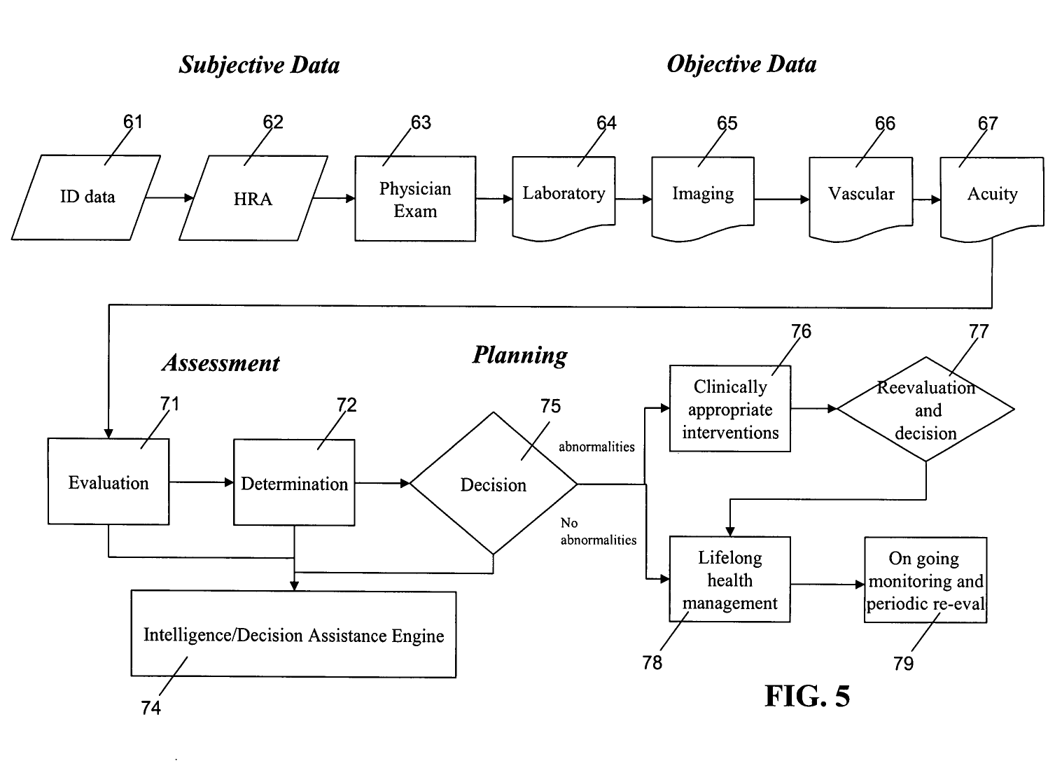

As shown in FIG. 5, the present invention can operate so as to receive the client subjective data, such as identification data 60, Health Risk Assessment (HRA) data 61, and physician exam data 62, as well as client objective data, such as laboratory 63, imaging 64, vascular 65 and acuity 66 data. This data can be used in the assessment phase by evaluating the data as at 71 and determining an appropriate feedback for the client as at 72, whether the feedback is informational, advice-oriented, treatment-oriented or otherwise. In this aspect, the system of the present invention employs a physician review 75 as well as the intelligence or decision assistance engine 74 to assist in the evaluation and determination appropriate for the client involved, as described above. The planning stage, as further shown in FIG. 5, involves further steps based upon the physician's decision as to whether the client's information involves abnormalities or no abnormalities. For example, if the physician and/or the testing detects abnormalities, a recommendation for clinically appropriate interventions and/or specialist examinations can be made as at 76 and later reevaluation and decision making can be made as at 77. If no abnormalities appear to be involved, the physician can recommend periodic follow up diagnostic monitoring and physical examinations as at 78 in conjunction with the development of a lifelong health management plan as at 79. As shown in FIG. 5, the present invention directs the process flow to lifelong health management, continued monitoring and periodic reevaluation and decision making regardless of whether abnormalities are detected.

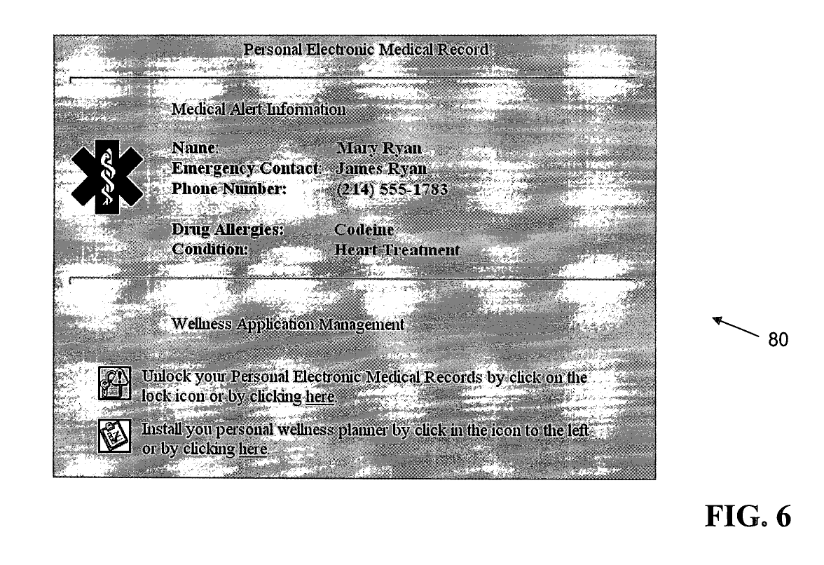

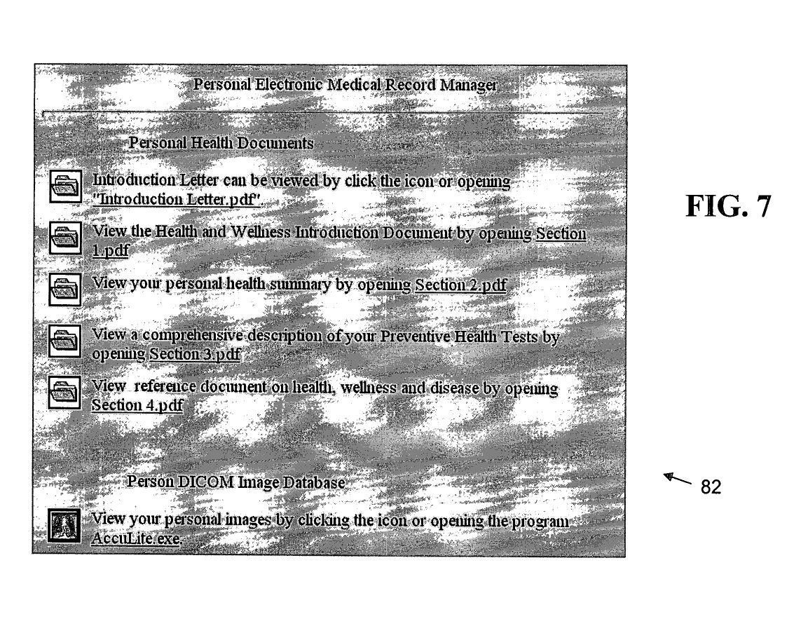

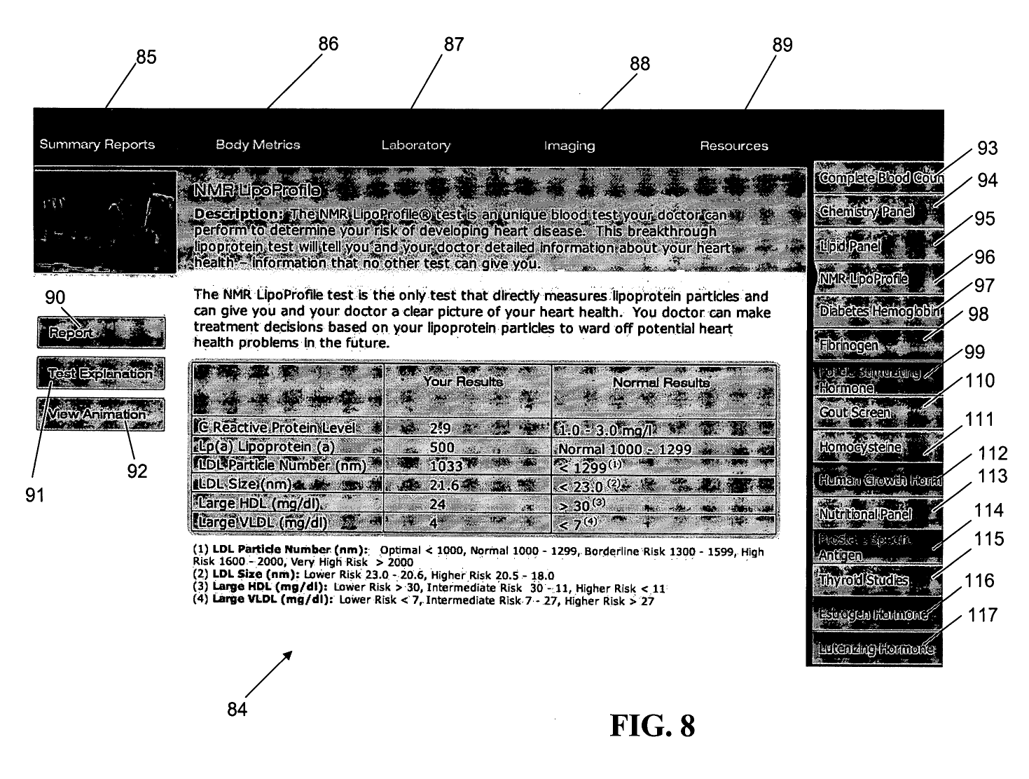

FIGS. 6 through 8 illustrate sample screen shots or interfaces that a client might encounter when using the system of the present invention. For example, FIG. 6 illustrates a sample screen shot 80 showing a medical alert regarding the client's allergy to the drug codeine, as well as the client's preexisting heart condition. FIG. 7 illustrates a selection of personal health documents available in menu format 82 for the client. These documents can be provided either by the system of the present invention or by third party data providers as described above. FIG. 8 illustrates a sample interface 84 that a client can use in connection with the personal smart drive device provided in accordance with one aspect of the present invention, and described in more detail below.

The Device

As described above, when the client exits the preventive medicine facility after a physical assessment, he or she is provided with a smart drive device. The device can include a storage component having general and user-specific health and wellness information. The general information can include information available to every user of the present invention, such as charts and graphics depicting statistical likelihood of various disease onsets for individuals at certain ages, genders and other risk categories. The user-specific health information can include the user's height, weight, date of birth, test results, statistics, personal assessment, and so forth. In one embodiment of the present invention, at least a portion of the user-specific information is customized to the user based upon externally conducted health tests and not based upon self-reported data. In another embodiment of the present invention, the general and user-specific information includes text, images, sound and video-formatted information to provide a fully function multi-media experience for the user. In this way, the user can more easily glean information and an understanding of his or her own health and the factors that relate to his or her particular situation and/or profile. It will be appreciated that the storage component can include a medical records component storing past and current medical information for the given user. In one embodiment, the medical records component can be updated remotely by a health care professional interfacing with the health and wellness management system. It will further be appreciated that the storage component can store one or more personal health plans for the given user.

The device can further be provided with an electronic, interactive user interface allowing the user to receive the general and user-specific information by personal computer or other computing device. For example, the user can visit a preventive medical facility in person and have a variety of assessment tests performed. Upon leaving the facility, the user can be presented with the USB smart drive device, and the user can plug the smart drive device into his or her home computer upon returning home. Upon inserting the smart drive device, the user can be presented with an interactive user interface (e.g., browser-based) that allows the user to see his or her assessment, test results and other information. The user interacts, for example, through input devices such as a keyboard, mouse, microphone, for example, receiving feedback visually and audibly through text, video, audio, and image presentations. It will be appreciated that the user interface allows the user to input and manage information pertaining to one or more health/intervention plans established for the user. In one embodiment of the invention, the user-inputted information can be transmitted to the centralized system and one or more health care professionals for evaluation and feedback. The present invention can further include a plan revision component for updating the one or more health plans based upon the user-inputted information.

FIG. 8 shows a sample interface 84 that a user can interact with in connection with the features described above. For example, the user can see summary reports as at 85, body metrics information as at 86, laboratory results as at 87, imaging results as at 88 and research as at 89. The body metrics tab 86 is highlighted in FIG. 8, and on this interface, the user can select a report as at 90, a test explanation as at 91 and an animation for viewing pertaining to the test involved as at 92. The animation can greatly facilitate client learning about the test and its relevance to the client. The body metric tests are identified in the right hand column of the sample interface 84, and the sample test identified in the interface 84 is an NMR™ Lipoprofile test 96. Other tests shown in interface 84 include, for example, complete blood count 93, chemistry panel 94, lipid panel 95, diabetes hemoglobin 97, fibrinogen 98, follicle stimulating hormone 99, gout screen 110, hormocysteine 111, human growth hormone 112, nutritional panel 113, prostate specific antigen 114, thyroid studies 115, estrogen hormone 116 and lutenizing hormone 117.

The device further includes programming to facilitate user communication with the centralized, electronic health and wellness information management system 16. The device can include its own communication software, for example, which allows a user to connect to a network such as the Internet by dial-up, satellite, digital subscriber line (DSL), cable, fiber optic or other known link. Further, the device can include programming which operates on an operating platform such as Microsoft XP™, for example, whereby the user can interface with the centralized system through the above-described user interface (as long as the user's computer maintains a live network connection). The user's browser software can be stored either locally on the device or on the user's home or other computer into which the USB drive device is plugged. The centralized health and wellness information management system 11 can be provided with an information repository of health and wellness best practices information, for example, that includes general information suitable to all users. The centralized system can further receive personalized information from the user, who upon logging in and being verified, can extract more customized information and intervention recommendations from the centralized system. In one embodiment of the present invention, the centralized system can further have an input interface for receiving reports, test information, care solutions and recommendations from one or more health professionals, which can then be customized to the user. The input interface can be adapted to receive general information from health care professionals who may have never interacted with the particular customer, and can further be adapted to receive customer-specific information from health care professionals who have personally interacted with the customer.

For example, if Mr. Jones visits Preventive Facility in Phoenix, Ariz. and is engaged by Dr. Philbin for testing and assessment, Dr. Philbin may later provide information into the centralized information management system that is available only for Mr. Jones. When Mr. Jones finishes his in-person visit, he receives his smart drive device and returns home. Upon plugging his smart drive device into his computer, Mr. Jones can view the test results and analysis from his health assessment. For example, he can read the text stating his results. He can also watch and listen to a video presentation that animates various issues related to his assessment (e.g., if he has borderline hypertension, he can watch an animation showing the effects of high blood pressure and various treatments on the bloodstream). He can further log into the centralized system to gather more information on his assessment. Upon logging into the system, Mr. Jones can see a variety of general, user non-specific information which augments the previous information he had viewed. He can also view customized information provided by Dr. Philbin, such as, for example, Dr. Philbin's treatment statistics with different patients taking different hypertension medications (non-personal information only). Mr. Jones can further receive an intervention plan and/or recommendation from Dr. Philbin as well as the centralized system. In one embodiment of the invention, the intervention plan is provided on the user's smart drive device as he/she is leaving the facility in which he/she was assessed. In another embodiment of the invention, the user's test results and assessment from the physical participation at the facility are evaluated (e.g., by the attending health care professional, by a non-attending professional, or through an automated computer program process combined with a health care professional), and a subsequent intervention plan is made available for the user by logging in to the centralized system.

In one aspect, the present invention thus provides a method for recommending an individual health intervention strategy. The central system receives client objective data based upon the client's visit to a preventive health care facility, which can be one of a plurality of facilities located throughout the world. The invention determines client subjective data based upon information obtained from the client. For example, the subjective data can include client identification data, health risk assessment data and physician exam data (past or current), and the objective data can include laboratory data, imaging data, vascular data and acuity data. The system can then evaluate the physical health of the client based in part on the client visit, and can determine from the evaluation whether the client displays one or more abnormalities. In one embodiment, the central system manages this evaluation and determination via the analysis component 42, which can operate with or without oversight by an evaluating health professional. Based upon the evaluation, the decision assistance engine 47 can determine (or help determine) a recommendation for the client based upon the objective data, the subjective data and the evaluation. As described above, the client objective data, subjective data, and evaluation data obtained from evaluating the health of the client can be stored on the portable information storage device, which is capable of communication through a computerized device with a centralized preventive health management system.

In one aspect of the present invention, the decision support component can improve its analysis and assessments over time as more data is collected and analyzed. In one embodiment of this aspect of the present invention, the decision assistance component can recommend different assessment tests to new individual clients based on age and gender as a result of analysis of current clients as described above. Any modifications to existing testing procedures such as may be stored in the SOP, for example, can be immediately disseminated throughout the network such that each facility operates on most current knowledge and database of forms and testing procedures, for example. In another related aspect of the invention, an outcomes measurement component is provided as part of the centralized health management system, wherein the outcomes measurement component can store information about various clients and their intervention programs, including outcomes associated with the various intervention programs, in order to evaluate the efficacy of the intervention programs. For example, if an intervention plan for a 50-year old male smoker includes a program requiring 30 minutes of cardiovascular exercise three times a week, and a separate client with a different intervention plan reports certain individual health successes by exercising cardiovascularly for 45 minutes and four times per week, then the outcomes measurement component may analyze such information and make new recommendations for longer and more frequent cardiovascular exercise for the 50-year old smoker and possibly other clients.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. An electronic device for managing personal health care, comprising:
a storage component having general and user-specific health and wellness information, at least a portion of which is customized to a given user based upon externally conducted health tests and not based upon self-reported data, said information including text, images, sound and video-formatted information;
an electronic interactive user interface allowing the given user to receive said information by personal computer or other computing device; and
means for interfacing with a centralized, electronic health and wellness information management system, said system having an information repository of health and wellness information, and further having an input interface for receiving reports, test information, care solutions and intervention recommendations from one or more health professionals and customized to the given user.

2. The device of claim 1 wherein the customized information is accessible only by the given user and any user-designated health care professional.

3. The device of claim 1 wherein the storage component, interface and interfacing means comprise a portable smart drive device.

4. The device of claim 1 wherein the storage component includes a medical records component storing past and current medical information for the given user, said medical records component being updatable remotely by a health care professional interfacing with the health and wellness management system.

5. The device of claim 1 wherein the storage component stores one or more personal health plans for the given user, and wherein the user interface allows the user to input and manage information pertaining to the one or more health plans.

6. The device of claim 4 wherein the user-inputted information can be transmitted to the centralized system and one or more health care professionals for evaluation and feedback.

7. The device of claim 4 further including a plan revision component for updating the one or more health plans based upon the user-inputted information.

8. A method for recommending an individual health intervention strategy, comprising the steps of:
receiving client objective data based upon a client visit to a preventive health care facility, wherein the facility is part of a system including a plurality of such facilities in different geographical areas connected by a network;
determining client subjective data;
evaluating the physical health of the client based in part on the client visit;
determining, from the evaluation, whether the client displays one or more abnormalities; and
determining, using a computer-implemented engine, a recommendation for the client based upon the objective data, subjective data and evaluation.

9. The method of claim 8 wherein the subjective data can include client identification data, health risk assessment data, physician exam data, and the objective data can include, laboratory data, imaging data, vascular data and acuity data.

10. The method of claim 8 including the step of storing the client objective data, subjective data, and evaluation data obtained from the step of evaluating the health of the client on a portable information storage device which is capable of communication through a computerized device with a centralized preventive health management system.

11. The method of claim 8 wherein the network provides access to a centralized health facility operations management system and centralized preventive health management system, and wherein the client is provided with a portable smart drive device after the personal client visit which provides access to the centralized preventive health management system.

12. The method of claim 11 wherein the portable smart drive device general and user-specific health and wellness information, at least a portion of which is customized to a given user based upon externally conducted health tests and not based upon self-reported data, said information including text, images, sound and video-formatted information.

13. A networked, preventive medicine system, comprising:
a plurality of physical preventive medical centers equipped with at least one of diagnostic imaging equipment or laboratory testing equipment;
a wide area computer network capable of allowing each of said medical centers to communicate with one another;
a centralized health facility operations management system in communication with the computer network;
a centralized preventive health management system in communication with the computer network;
one or more health information content providers in communication with the computer network;
a client services interface in communication with the computer network for providing client informational services to one or more clients attending one of the preventive medical centers; and
at least one personal electronic device for managing health care information, comprising at least a storage component having health and wellness information, at least a portion of which is customized to a given client based upon externally conducted health tests at one of the preventive medical centers and not based upon self-reported data, said information including text, images, sound and video-formatted information.

14. The system of claim 13 wherein the personal device includes means for interfacing with the information management system for receiving reports, test information, care solutions and recommendations from one or more health professionals and customized to the given user.

15. The system of claim 13 further including an outcomes measurement component for storing non-personal intervention plan and outcome information for a plurality of users, and for evaluating the efficacy of the stored intervention plan information so as to communicate updates and changes to the preventive health management system for optimizing testing and intervention plans.

16. A method for converting a standalone health facility to an assessment-intervention facility which is a member of a network of a plurality of assessment-intervention facilities, comprising the steps of:
receiving a request from a health facility operator;
issuing a standard operations procedure (SOP) package detailing specific guidelines associated with being a member of an assessment-intervention facility network;
implementing an information technology infrastructure to enable the health facility operator to follow the SOP and communicate with the network, said implementing step including the step of providing a personal device for managing health care information, wherein the personal device comprises at least a storage component having health and wellness information, at least a portion of which is customized to a given user based upon externally conducted health tests at one of the preventive medical centers and not based upon self-reported data, said information including text, images, sound and video-formatted information.

17. The method of claim 16 including the step of providing central hosting services for said facility.

18. The method of claim 16 including the step of providing a testing analytics component for collecting post-testing information from clients, aggregating the data, and analyzing the data to determine whether testing procedures for new clients are to be modified.

19. A computerized method for determining optimal testing on an age-gender basis in connection with an assessment-intervention program, comprising the steps of:
providing health and wellness testing standards for health clients based upon age and gender;
storing the testing standards in a database;
performing one or more health or wellness tests on multiple clients participating in a health assessment-intervention program;
collecting post-testing information about the clients, including information pertaining to a common symptom or disease exhibited by a plurality of the clients; and
analyzing the collected data to determine whether the one or more tests are to be modified for use with new clients.

20. The method of claim 19 including the further step of modifying the stored testing standards according to results determined from the analyzed data.

21. The method of claim 19 wherein the stored testing standards and any modified testing standards are disseminated to a plurality of assessment-intervention facilities via a network.
